(19) United States
(12) Patent Application Publication
(10) Pub. No.: US 2026/0204456 A1
(43) Pub. Date: Jul. 16, 2026

(54) FLEXIBLE FLAT CABLE WITH TERMINAL AND METHOD FOR MANUFACTURING SAME

(71) Applicant: Proterial, Ltd., Tokyo (JP)

(72) Inventors: Hiroshi YAMADA, Tokyo (JP); Tomoyuki MURAYAMA, Tokyo (JP)

(73) Assignee: Proterial, Ltd., Tokyo (JP)

(21) Appl. No.: 19/423,682

(22) Filed: Dec. 17, 2025

(30) Foreign Application Priority Data
Jan. 10, 2025 (JP) 2025-004318

(51) Int. Cl. H01B 7/08

(52) U.S. Cl. CPC H01B 7/0823; H01B 7/0838

(57) ABSTRACT

A flexible flat cable with terminal includes a plurality of strip conductors, an insulating film covering both sides of the plurality of strip conductors except for both ends in a longitudinal direction thereof, and a plurality of terminals connected to respective ends of the plurality of strip conductors, wherein terminals among the plurality of terminals are connected to two or more of the plurality of strip conductors in a one-to-many configuration, and other terminals are each connected to one of the plurality of strip conductors in a one-to-one configuration.

### CROSS-REFERENCE TO RELATED APPLICATIONS

The present application is based on Japanese patent application No. 2025-004318 filed on January 10, 2025, the entire contents of which are incorporated herein by reference.

### TECHNICAL FIELD

The present invention relates to a flexible flat cable with terminal in which plural strip conductors connected to terminals at their ends are covered with an insulating film, and a method for manufacturing the same.

### BACKGROUND OF THE INVENTION

Conventionally, flexible flat cables, in which strip conductors are covered with an insulating film, are sometimes used, e.g., for connections between electronic devices (see, e.g., Patent Literatures 1 and 2).

The cable described in Patent Literature 1 includes a flat cable formed by covering plural flat conductors with insulation, plural connector terminals, and a housing that holds each connector terminal. The plural flat conductors are arranged side by side in the width direction at a predetermined pitch. The connector terminals are connected to terminal welding portions formed at ends of the flat conductors by laser welding or laser soldering.

The flexible flat cable described in Patent Literature 2 is configured such that three flexible harness portions, which are individually separated from each other by slits and arranged in parallel, constitute a separated-harness stacked portion. Among the three flexible harness portions, the flexible harness portion at the center has two signal line pattern portions, while the flexible harness portions on the both sides each have a ground line pattern portion. The ground line pattern portions are formed wider than the signal line pattern portions. Citation List Patent Literature 1: JP 2023-171116A Patent Literature 2: JP 2013-206826A (see paragraphs 0046 to 0048, and FIG. 10)

### SUMMARY OF THE INVENTION

When signal transmission and power supply are performed through plural conductors in one flexible flat cable, the width of the conductors for power supply is desirably larger than the width of the conductors for signal transmission in view of the amount of current. However, specifications for flexible flat cables, such as the number of conductors, vary depending on the configurations and functions of the electronic devices to be connected, and when the widths of the conductors for power supply differ from those for signal transmission, even more cable types become necessary. An increase in the number of flexible flat cable types increases changeover time for manufacturing equipment during production, raising production costs.

Therefore, the present inventors conducted extensive research and came up with the idea that even if plural conductors constituting a flexible flat cable have the same width, signal transmission and power supply can be performed together using a single flexible flat cable by devising a configuration of terminals to be connected to ends of the plural conductors, which led to the present invention. That is, it is an object of the invention to provide a flexible flat cable with terminal that can accommodate various specifications while configuring plural conductors constituting a flexible flat cable to have the same width, and a method for manufacturing the same.

To solve the above problem, the invention provides a flexible flat cable with terminal, comprising:

a plurality of strip conductors;

an insulating film covering both sides of the plurality of strip conductors except for both ends in a longitudinal direction thereof; and

a plurality of terminals connected to respective ends of the plurality of strip conductors,

wherein terminals among the plurality of terminals are connected to two or more of the plurality of strip conductors in a one-to-many configuration, and other terminals are each connected to one of the plurality of strip conductors in a one-to-one configuration.

To solve the above problem, the invention also provides a method for manufacturing a flexible flat cable with terminal that comprises a plurality of strip conductors, an insulating film covering both sides of the plurality of strip conductors

except for both ends in a longitudinal direction thereof, and a plurality of terminals connected to respective ends of the plurality of strip conductors, the method comprising:

a cutting step of cutting a linear base of a conjoined group of terminals to separate into the plurality of terminals, the base being connected by coupling portions to a plurality of fitting portions to be connected to mating terminals;

a first connecting step of connecting terminals among the plurality of terminals to two or more of the plurality of strip conductors in a one-to-many configuration; and

a second connecting step of connecting other terminals among the plurality of terminals to any of the plurality of strip conductors in a one-to-one configuration,

wherein in the cutting step, the base is cut longer when cutting out the terminals than when cutting out the other terminals, and

wherein in the first connecting step, the bases of the terminals are each connected to the two or more strip conductors.

### Advantageous Effects of the Invention

According to the flexible flat cable with terminal and its manufacturing method of the invention, it is possible to accommodate various specifications while configuring plural conductors constituting a flexible flat cable to have the same width.

### BRIEF DESCRIPTION OF DRAWINGS

FIG. 1A is a front view showing a flexible flat cable with terminal.

FIG. 1B is a side view thereof.

FIG. 1C is a rear view thereof.

FIG. 2 is an enlarged view showing both end portions of the flexible flat cable with terminal shown in FIG. 1B.

FIG. 3A is a front view showing a connectorized flexible flat cable.

FIG. 3B is a side view thereof.

FIG. 3C is a rear view thereof.

FIG. 4 is an enlarged view showing both end portions of the connectorized flexible flat cable shown in FIG. 3B.

FIG. 5 is a perspective view showing an end portion of the flexible flat cable with terminal.

FIG. 6 is a perspective view showing an end portion of the connectorized flexible flat cable.

FIG. 7 is a plan view showing an end portion of the flexible flat cable with terminal.

FIG. 8 is a perspective view showing a conjoined group of terminals.

FIG. 9 is a perspective view showing plural terminals obtained by cutting and separating the conjoined group of terminals.

FIGS. 10A, 10B, and 10C are explanatory diagrams illustrating the connecting step of welding terminals to strip conductors.

FIGS. 11A, 11B, and 11C are front views showing the flexible flat cables with terminal and the connectorized flexible flat cables in modified examples.

FIG. 12A is a front view showing the flexible flat cable with terminal and the connectorized flexible flat cable in the second embodiment.

FIG. 12B is a side view thereof.

FIG. 12C is a rear view thereof.

FIG. 13 is an enlarged view showing both end portions of the connectorized flexible flat cable shown in FIG. 12B.

FIG. 14 is a perspective view showing terminals for power supply in the second embodiment.

### DETAILED DESCRIPTION OF THE INVENTION

### First embodiment

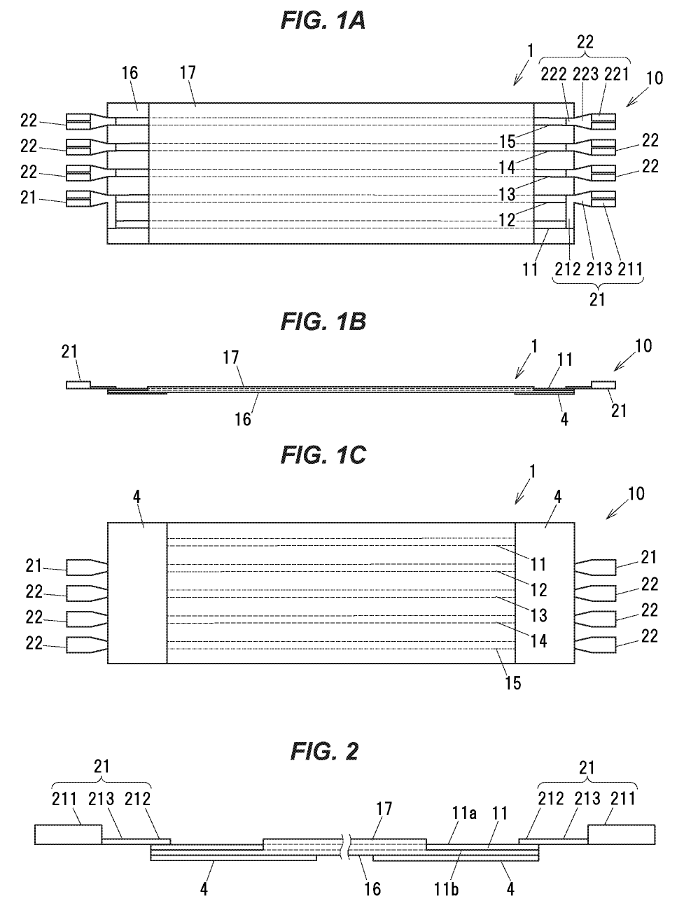

The first embodiment of the invention will be described with reference to FIGS. 1A to 10C. FIG. 1A is a front view showing the front surface side of a flexible flat cable with terminal 10 in which plural terminals 21 and 22 are connected to a flexible flat cable 1. FIG. 1B is a side view showing the flexible flat cable with terminal 10. FIG. 1C is a rear view of the back surface of the flexible flat cable, showing terminal 10. FIG. 2 is an enlarged view showing both end portions of the flexible flat cable with terminal 10 shown in FIG. 1B.

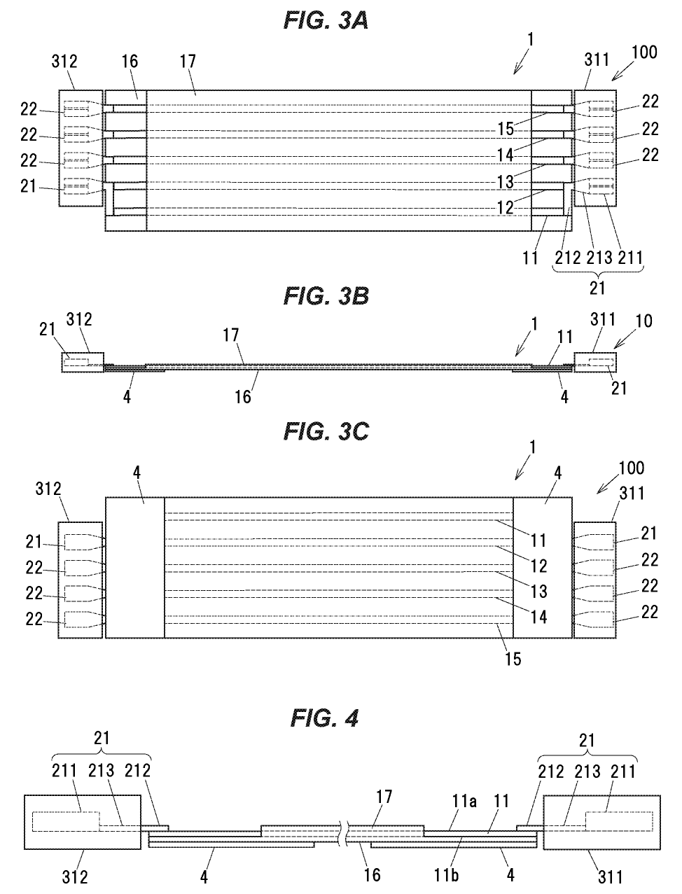

FIG. 3A is a front view showing the front surface side of a connectorized flexible flat cable 100 in which connector housings 311 and 312 are further provided on the flexible flat cable with terminal 10. FIG. 3B is a side view showing the connectorized flexible flat cable 100. FIG. 3C is a rear view showing the back surface side of the connectorized flexible flat cable 100. FIG. 4 is an enlarged view showing both end portions of the connectorized flexible flat cable 100 shown in FIG. 3B. The connector housings 311 and 312 are resin members that hold the plural terminals 21 and 22. The plural terminals 21 and 22 and the connector housings 311 and 312 constitute connectors that are removably connected to devices.

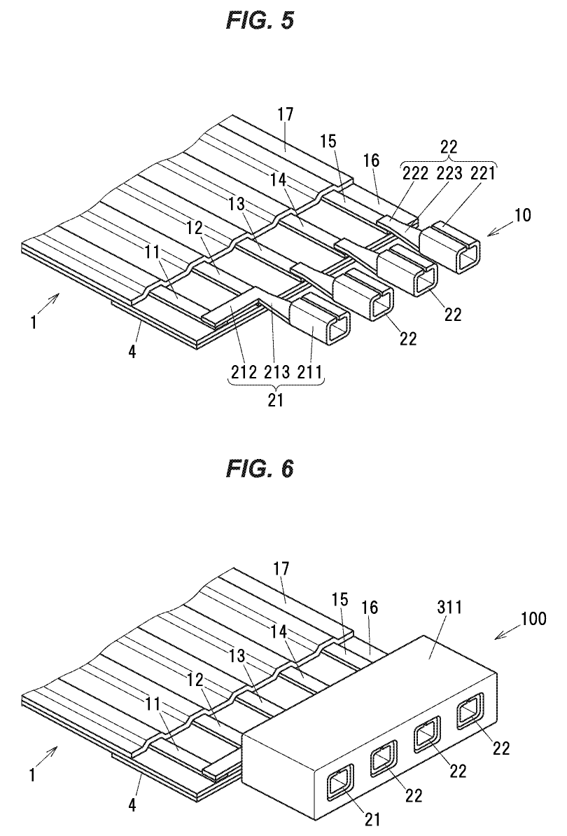

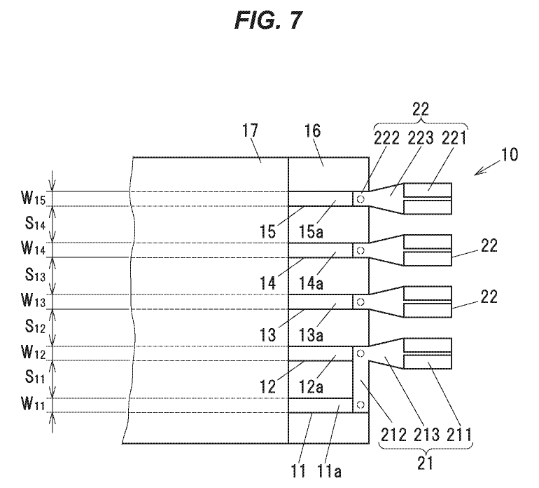

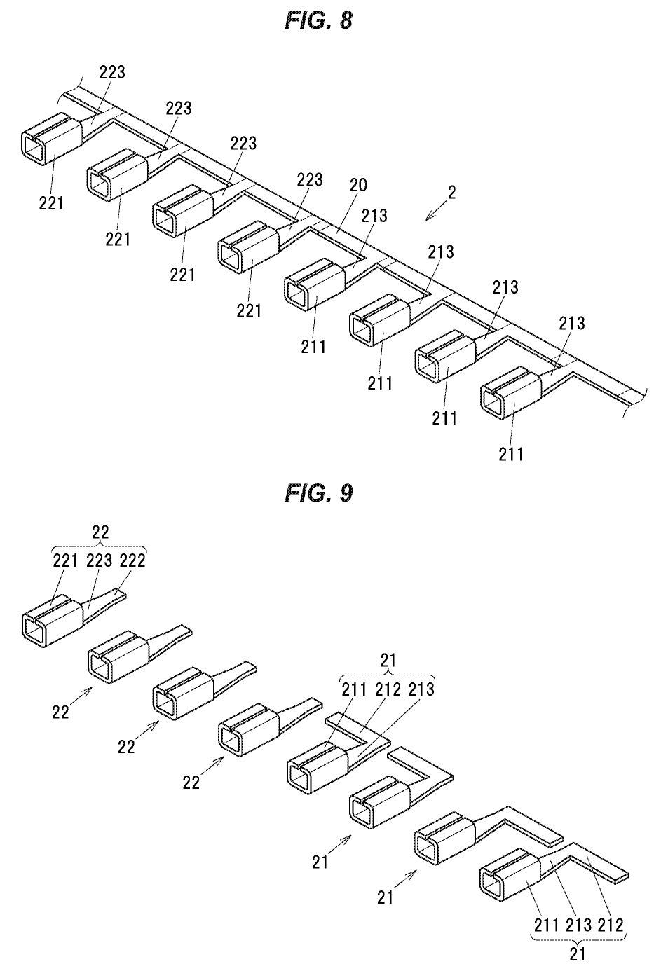

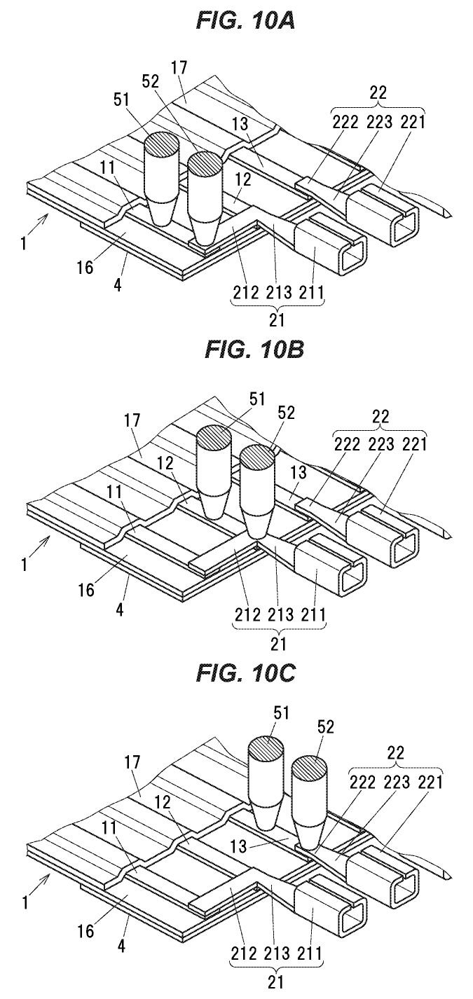

FIG. 5 is a perspective view showing an end portion of the flexible flat cable with terminal 10. FIG. 6 is a perspective view showing an end portion of the connectorized flexible flat cable 100. FIG. 7 is a plan view showing an end portion of the flexible flat cable with terminal 10. FIG. 8 is a perspective view showing a conjoined group of terminals 2. FIG. 9 is a perspective view showing plural terminals 21 and 22 obtained by cutting and separating the conjoined group of terminals 2 at plural locations. FIGS. 10A, 10B, and 10C are explanatory diagrams illustrating an example of a connecting step of welding terminals 21 and 22.

The flexible flat cable 1 includes plural strip conductors 11 to 15, and insulating films 16 and 17 covering both sides of the plural strip conductors 11 to 15 except for both ends in a longitudinal direction thereof. The strip conductors 11 to 15 are strip-shaped conductor lines made of, e.g., copper or a copper alloy, and are arranged parallel to each other at predetermined intervals. As shown in FIG. 7, respective conductor widths W₁₁ to W₁₅ of the strip conductors 11 to 15 are the same, and spacings S₁₁ to S₁₄ between the strip conductors 11 to 15 are also the same. In FIGS. 1A to 4 and 7, the strip conductors 11 to 15, as seen through the insulating films 16 and 17, are indicated by dashed lines. Hereinafter, the strip conductors 11 to 15 will be respectively referred to as the first strip conductor 11, the second strip conductor 12, the third strip conductor 13, the fourth strip conductor 14, and the fifth strip conductor 15.

The insulating films 16 and 17 are made of, e.g., an insulating resin with excellent flexibility, such as polyester resin or polyphenylene sulfide resin, and are bonded together with the first to fifth strip conductors 11 to 15 sandwiched therebetween. The insulating films 16 and 17 each have an adhesive layer on the side facing each other, are bonded together by, e.g., applying pressure while heating using a heating roller, and are integrated together with the first to fifth strip conductors 11 to 15.

The first to fifth strip conductors 11 to 15 have their both longitudinal ends exposed from between the insulating films 16 and 17. The insulating film 16 on the back surface side of the flexible flat cable 1 covers the back surfaces of the first to fifth strip conductors 11 to 15 over the entire longitudinal length of the first to fifth strip conductors 11 to 15. The insulating film 17 on the front surface side covers the front surfaces of the first to fifth strip conductors 11 to 15 except for both end portions in the longitudinal direction of the first to fifth strip conductors 11 to 15. In FIGS. 2 and 4, the front surface of the first strip conductor 11 is indicated by the reference numeral 11a, and its back surface is indicated by the reference numeral 11b.

Support plates 4 made of resin are arranged at both longitudinal ends of the flexible flat cable 1 so as to correspond to the portions where the first to fifth strip conductors 11 to 15 are exposed from between the insulating films 16 and 17. The support plates 4 serve to reinforce both longitudinal ends of the flexible flat cable 1 so that the first to fifth strip conductors 11 to 15 exposed from between the insulating films 16 and 17 do not bend excessively. The support plates 4 are bonded to the insulating film 16 on the back surface side by, e.g., an adhesive.

In the present embodiment, among the first to fifth strip conductors 11 to 15, the first and second strip conductors 11 and 12 are used as conductor lines for power supply, while the third to fifth strip conductors 13 to 15 are used as conductor lines for signal transmission that transmit electrical signals. Power supply terminals 21 are connected to ends of the first and second strip conductors 11 and 12, one each on one side and the other side in the longitudinal direction. Signal transmission terminals 22 are respectively connected to one longitudinal end and the other longitudinal end of each of the third to fifth strip conductors 13 to 15. In other words, in the present embodiment, terminals 21 among the terminals 21, 22 are connected to two or more (in this example, the first and second strip conductors 11 and 12) of the first to fifth strip conductors 11 to 15 in a one-to-many configuration, while other terminals 22 are each connected to one of the first to fifth strip conductors 11 to 15 (in this example, one of the third to fifth strip conductors 13 to 15) in a one-to-one configuration.

The power supply terminal 21 has a fitting portion 211 to be connected to a mating terminal, an extending portion 212 extending in a direction intersecting the longitudinal direction of the first to fifth strip conductors 11 to 15, and a coupling portion 213 coupling the fitting portion 211 to the extending portion 212, and the extending portion 212 is connected to the first and second strip conductors 11 and 12. The signal transmission terminal 22 has a fitting portion 221 to be connected to a mating terminal, a connection portion 222 connected to one of the third to fifth strip conductors 13 to 15, and a coupling portion 223 coupling the fitting portion 221 to the connection portion 222. By means of welding, the extending portions 212 of the terminals 21 are each connected to the first and second strip conductors 11 and 12 and the respective connection portions 222 of the terminals 22 to the third to fifth strip conductors 13 to 15. In FIG. 7, the welding points on the terminals 21 and 22 are shown enclosed by dashed lines.

Next, a method for manufacturing the flexible flat cable with terminal 10 will be described. The method for manufacturing the flexible flat cable with terminal 10 includes a cutting step of cutting the conjoined group of terminals 2 (see FIG. 8) at plural locations to separate into plural terminals 21, 22, a first connecting step of connecting the terminals 21 to the first and second strip conductors 11, 12, and a second connecting step of respectively connecting the plural terminals 22 to the third to fifth strip conductors 13 to 15.

As shown in FIG. 8, the conjoined group of terminals 2 has a linear base 20 to which fitting portions 211 and 221 are integrally connected by coupling portions 213 and 223. In the cutting step, the base 20 of the conjoined group of terminals 2 is cut with, e.g., a cutting tool such as nippers to separate into plural terminals 21 and 22. In FIG. 8, the positions to cut the base 20 in the cutting step are indicated by dashed lines. The lengths of the bases 20 after being cut off so that the coupling portions 213, 223 are integrated therewith are different between the power supply terminals 21 and the signal transmission terminals 22, and the base 20 is cut longer when cutting out the power supply terminals 21 than when cutting out the signal transmission terminals 22. The base 20 cut off when cutting out the power supply terminal 21 becomes the extending portion 212 of the terminal 21. The base 20 cut off when cutting out the signal transmission terminal 22 becomes the connection portion 222 of the terminal 22.

FIGS. 10A and 10B show the first connecting step. In the first connecting step, the terminal 21 is connected to the first and second strip conductors 11 and 12 by welding in a one-to-many configuration. The first and second strip conductors 11 and 12 are connected in parallel between two terminals 21, which are connected to one longitudinal end and the other longitudinal end of the first and second strip conductors 11 and 12. FIG. 10A shows the state when one end of the extending portion 212 of the terminal 21 is connected to the first strip conductor 11, and FIG. 10B shows the state when the other end of the extending portion 212 of the terminal 21 is connected to the second strip conductor 12.

The welding in the first connecting step is performed using an indirect method which uses a pair of electrodes 51 and 52 and in which one electrode 52 is pressed against the extending portion 212 of the terminal 21 while the other electrode 51 is pressed against a front surface 11a, 12a of the first or second strip conductor 11 or 12 (see FIG. 7), and an electric current is passed between the pair of electrodes 51, 52. The extending portion 212 of the terminal 21 and the first and second strip conductors 11 and 12 are welded together by Joule heating generated by the current flowing between the pair of electrodes 51 and 52.

The welding of one end of the extending portion 212 of the terminal 21 to the first strip conductor 11 and the welding of the other end of the extending portion 212 of the terminal 21 to the second strip conductor 12 may be performed in either order, or may be performed simultaneously. In addition, when welding the terminal 21 to the first strip conductor 11, the welding may be performed in such a manner that one electrode 51 is pressed against the extending portion 212 of the terminal 21 located on one longitudinal end side of the first strip conductor 11 while the other electrode 52 is pressed against the extending portion 212 of the terminal 21 located on the other longitudinal end side of the first strip conductor 11, and an electric current is passed between the pair of electrodes 51, 52 through the first strip conductor 11. The same applies when welding the terminal 21 to the second strip conductor 12.

FIG. 10C shows the second connecting step. FIG. 10C shows the state when welding the connection portion 222 of the terminal 22 to the third strip conductor 13. The welding in the second connecting step is also performed using the indirect method which uses a pair of electrodes 51 and 52 and in which one electrode 52 is pressed against the connection portion 222 of the terminal 22 while the other electrode 51 is pressed against a front surface 13a, 14a, 15a of any of the third to fifth strip conductors 13 to 15 (see FIG. 7), and an electric current is passed between the pair of electrodes 51, 52, in the same manner as the welding in the first connecting step.

The welding of each of the third to fifth strip conductors 13 to 15 to the terminal 22 may be performed sequentially or simultaneously. In addition, when welding, e.g., the third strip conductor 13 to the terminals 22 at both ends, the welding may be performed in such a manner that one electrode 51 is pressed against the connection portion 222 of the terminal 22 located on one longitudinal end side of the third strip conductor 13 while the other electrode 52 is pressed against the connection portion 222 of the terminal 22 located on the other longitudinal end side of the third strip conductor 13, and an electric current is passed between the pair of electrodes 51, 52 through the third strip conductor 13. The same applies when welding the fourth and fifth strip conductors 14 and 15 to the terminals 22 at their both ends.

### Modifications

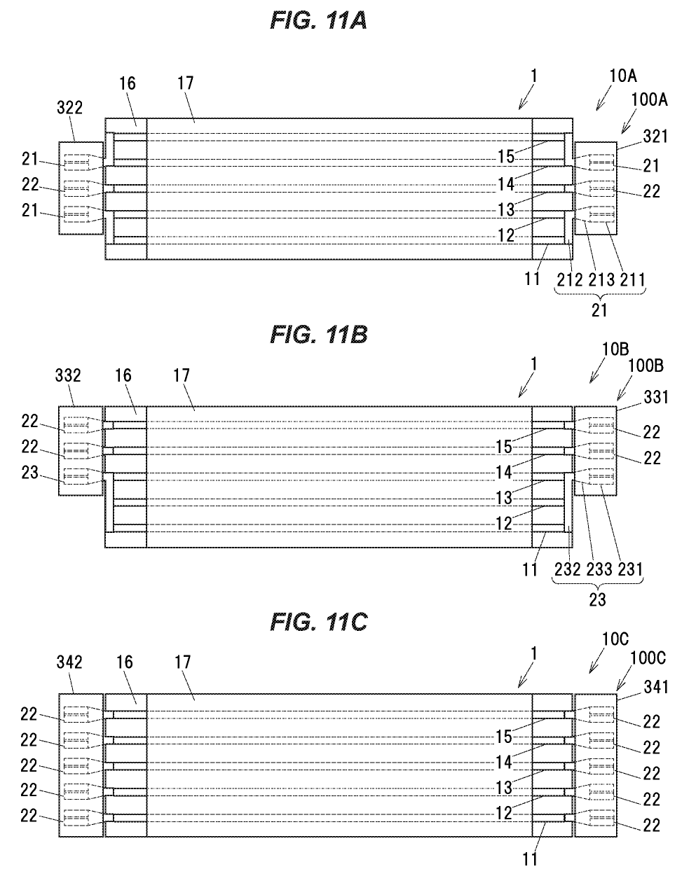

FIGS. 11A, 11B, and 11C are front views showing connectorized flexible flat cables 100A, 100B, and 100C which have connector housings 321, 322, 331, 332, 341, 342 attached to flexible flat cables with terminal 10A, 10B, and 10C in modified examples with different connection configurations.

In the flexible flat cable with terminal 10A shown in FIG. 11A, two power supply terminals 21 and one signal transmission terminal 22 are connected to each of one and other ends of the flexible flat cable 1. The first strip conductor 11 and the second strip conductor 12, as well as the fourth strip conductor 14 and the fifth strip conductor 15, are connected respectively in parallel by the terminals 21 and are used as conductor lines for power supply. The third strip conductor 13 has both ends respectively connected to the terminals 22 and is used as a conductor line for signal transmission.

In the flexible flat cable with terminal 10B shown in FIG. 11B, one power supply terminal 23 is connected to each of one and other ends of the flexible flat cable 1, and the first to third strip conductors 11 to 13 are connected in parallel between the two terminals 23. The terminal 23 has a fitting portion 231 to be connected to a mating terminal, an extending portion 232 extending in a direction intersecting the longitudinal direction of the first to fifth strip conductors 11 to 15, and a coupling portion 233 coupling the fitting portion 231 to the extending portion 232 in the same manner as the terminal 21, but the extending portion 232 is formed longer than the extending portion 212 of the terminal 21. The extending portion 232 is connected to ends of the first to third strip conductors 11 to 13 by welding.

In the flexible flat cable with terminal 10C shown in FIG. 11C, each of the first to fifth strip conductors 11 to 15 has both ends connected to the terminals 22 and are all used as conductor lines for signal transmission.

In this way, by modifying the terminal connection configuration while using the same flexible flat cable 1 without changing the configuration, it is possible to change which of the first to fifth strip conductors 11 to 15 is used as the conductor line for power supply and which is used as the conductor line for signal transmission, making it possible to accommodate various specifications. In other words, while using the same flexible flat cable 1 without changing the configuration, it is possible to accommodate various product configurations, such as the above-described connectorized flexible flat cables 100A to 100C, thereby enabling cost reduction.

### Second embodiment

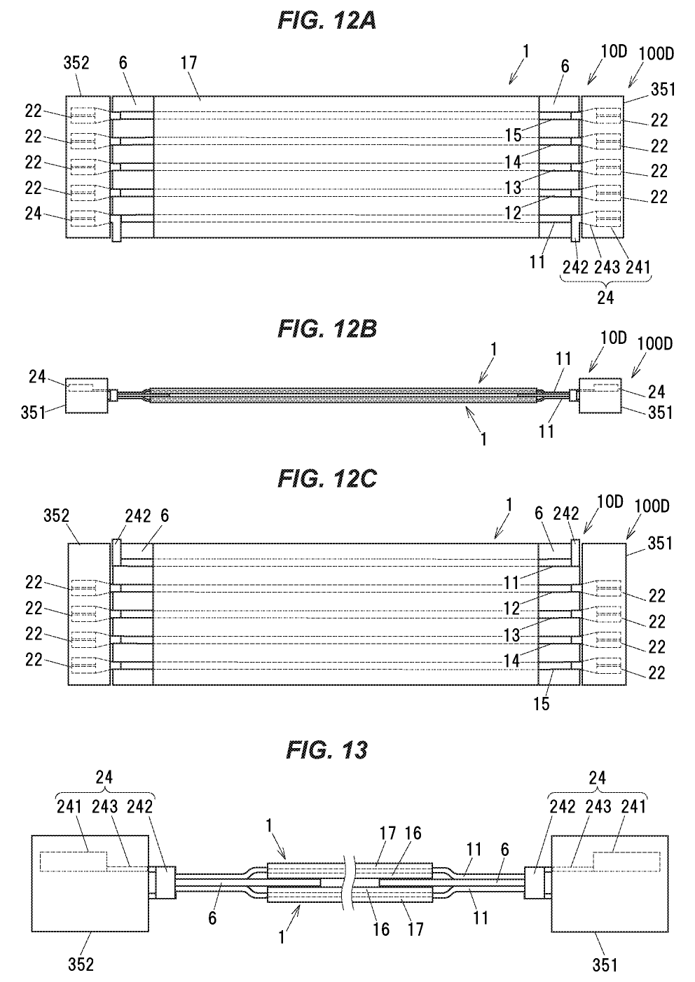

The second embodiment of the invention will be described with reference to FIGS. 12A to 14.

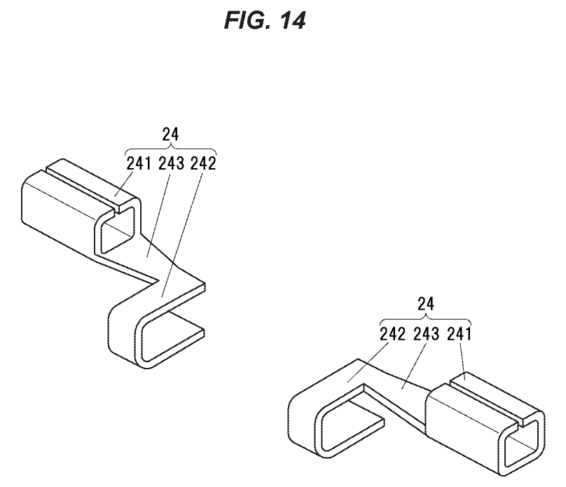

FIGS. 12A to 12C show a connectorized flexible flat cable 100D, which includes a flexible flat cable with terminal 10D obtained by combining two flexible flat cables 1 with plural signal transmission terminals 22 and power supply terminals 24, and further includes connector housings 351, 352 that hold the terminals 22, 24. FIG. 12A is a front view showing the front surface side of the connectorized flexible flat cable 100D, and FIG. 12B is a side view showing the connectorized flexible flat cable 100D. FIG. 12C is a rear view showing the back surface side of the connectorized flexible flat cable 100D. FIG. 13 is an enlarged view showing both end portions of the connectorized flexible flat cable 100D shown in FIG. 12B. FIG. 14 is a perspective view showing the power supply terminals 24.

Similarly to the flexible flat cable 1 in the first embodiment, the two flexible flat cables 1 have the first to fifth strip conductors 11 to 15 and the insulating films 16 and 17, and at both ends of the flexible flat cables 1, the first to fifth strip conductors 11 to 15 are exposed from between the insulating films 16 and 17. Support plates 6 made of an insulating resin are arranged between the first to fifth strip conductors 11 to 15 of one flexible flat cable 1 and the first to fifth strip conductors 11 to 15 of the other flexible flat cable 1. The insulating film 16 and the first to fifth strip conductors 11 to 15 of one flexible flat cable 1 and those of the other flexible flat cable 1 are adhered and fixed to the support plates 6. The signal transmission terminals 22 are connected to the respective ends of the second to fifth strip conductors 12 to 15 of one flexible flat cable 1 and those of the other flexible flat cable 1.

The terminal 24 has a fitting portion 241 to be connected to a mating terminal, a U-shaped curved extending portion 242, and a coupling portion 243 coupling the fitting portion 241 to the extending portion 242. The extending portion 242 is connected by welding to ends of the respective first strip conductors 11 of one flexible flat cable 1 and the other flexible flat cable 1. That is, in the second embodiment, the respective first strip conductors 11 of one flexible flat cable 1 and the other flexible flat cable 1 are connected in parallel by the terminals 24 and are used as conductor lines for power supply.

In this way, in the flexible flat cable with terminal 10D of the second embodiment, the first to fifth strip conductors 11 to 15 of one flexible flat cables 1 and those of the other flexible flat cables 1 are stacked in the thickness direction thereof with the support plates 6 serving as an insulation interposed therebetween, and each terminal 24 is connected to the respective first strip conductors 11 of one flexible flat cable 1 and the other flexible flat cable 1 which sandwich the support plates 6. Alternatively, the extending portion 242 of the terminal 24 may be made even longer, and, e.g., the respective first and second strip conductors 11 and 12 of one flexible flat cable 1 and the other flexible flat cable 1 may be connected by the extending portion 242. In other words, the extending portion 242 of the terminal 24 needs only to be connected to two or more of the first to fifth strip conductors 11 to 15 of one and other flexible flat cables 1.

Also in the second embodiment, by modifying the terminal connection configuration, it is possible to change which of the first to fifth strip conductors 11 to 15 is used as the conductor line for power supply and which is used as the conductor line for signal transmission, making it possible to accommodate products with various specifications. It is also possible to reduce the cost by using the common flexible flat cables 1.

### Summary of the embodiment

Technical ideas understood from the embodiment will be described below citing the reference signs, etc. used for the embodiment. However, each reference sign described below is not intended to limit the constituent elements in the claims to the members, etc., specifically described in the embodiment.

According to the first feature, a flexible flat cable with terminal 10, 10A, 10B, 10D comprises: a plurality of strip conductors 11 – 15; an insulating film 16, 17 covering both sides of the plurality of strip conductors 11 – 15 except for both ends in a longitudinal direction thereof; and a plurality of terminals 21 – 24 connected to respective ends of the plurality of strip conductors 11 – 15, wherein terminals 21, 23, 24 among the plurality of terminals 21 – 24 are connected to two or more of the plurality of strip conductors 1 – 15 in a one-to-many configuration, and other terminals 22 are each connected to one of the plurality of strip conductors in a one-to-one configuration.

According to the second feature, in the flexible flat cable with terminal 10, 10A, 10B, 10D as described in the first feature, the terminals 21, 23, 24 comprise a fitting portion 211, 231, 241 to be connected to a mating terminal, an extending portion 212, 232, 242 extending in a direction intersecting the longitudinal direction of the plurality of strip conductors 11 – 15, and a coupling portion 213, 233, 243 coupling the fitting portion 211, 231, 241 to the extending portion 212, 232, 242, and the extending portion 212, 232, 242 is connected to the two or more strip conductors.

According to the third feature, in the flexible flat cable with terminal 10, 10A, 10B, 10D as described in the second feature, the extending portions 212, 232, 242 of the terminals 21, 23, 24 are each connected to two or more strip conductors.

According to the fourth feature, in the flexible flat cable with terminal 10D as described in the first feature, the plurality of strip conductors 11 – 15 are stacked in a thickness direction thereof with an insulation (support plate 6) interposed therebetween, and the terminals 24 are connected to two or more strip conductors 11, among the plurality of strip conductors 11 – 15, that sandwich the insulation 6.

According to the fifth feature, a method for manufacturing a flexible flat cable with terminal 10, 10A, 10B, 10D that comprises a plurality of strip conductors 11 – 15, an insulating film 16, 17 covering both sides of the plurality of strip conductors 11 – 15 except for both ends in a longitudinal direction thereof, and a plurality of terminals 21 – 24 connected to respective ends of the plurality of strip conductors 11 – 15, the method comprising: a cutting step of cutting a linear base 20 of a conjoined group of terminals 2 to separate into the plurality of terminals 21 – 24 , the base 20 being coupled by coupling portions 213, 223, 233, 243 to a plurality of fitting portions 211, 221, 231, 241 to be connected to mating terminals; a first connecting step of connecting terminals 21, 23, 24 among the plurality of terminals 21 – 24 to two or more of the plurality of strip conductors 11 – 15 in a one-to-many configuration; and a second connecting step of connecting other terminals 22 among the plurality of terminals 21 – 24 to any of the plurality of strip conductors 11 – 15 in a one-to-one configuration, wherein in the cutting step, the base 20 is cut longer when cutting out the terminals 21, 23, 24 than when cutting out the other terminals 22, and wherein in the first connecting step, the bases 20 of the terminals 21, 23, 24 are each connected to the two or more strip conductors.

Although the embodiment of the invention has been described, the invention according to claims is not to be limited to the above-described embodiment. Further, please note that not all combinations of the features described in the embodiment are necessary to solve the problem of the invention.

1. A flexible flat cable with terminal, comprising:
a plurality of strip conductors;
an insulating film covering both sides of the plurality of strip conductors except for both ends in a longitudinal direction thereof; and
a plurality of terminals connected to respective ends of the plurality of strip conductors,
wherein terminals among the plurality of terminals are connected to two or more of the plurality of strip conductors in a one-to-many configuration, and other terminals are each connected to one of the plurality of strip conductors in a one-to-one configuration.

2. The flexible flat cable with terminal according to claim 1, wherein the terminals comprise a fitting portion to be connected to a mating terminal, an extending portion extending in a direction intersecting the longitudinal direction of the plurality of strip conductors, and a coupling portion coupling the fitting portion to the extending portion, and wherein the extending portion is connected to the two or more strip conductors.

3. The flexible flat cable with terminal according to claim 2, wherein the extending portions of the terminals are each connected to the two or more strip conductors.

4. The flexible flat cable with terminal according to claim 1, wherein the plurality of strip conductors are stacked in a thickness direction thereof with an insulation interposed therebetween, and wherein the terminals are connected to two or more strip conductors, among the plurality of strip conductors, that sandwich the insulation.

5. A method for manufacturing a flexible flat cable with terminal that comprises a plurality of strip conductors, an insulating film covering both sides of the plurality of strip conductors except for both ends in a longitudinal direction thereof, and a plurality of terminals connected to respective ends of the plurality of strip conductors, the method comprising:
a cutting step of cutting a linear base of a conjoined group of terminals to separate into the plurality of terminals, the base being connected by coupling portions to a plurality of fitting portions to be connected to mating terminals;
a first connecting step of connecting terminals among the plurality of terminals to two or more of the plurality of strip conductors in a one-to-many configuration; and
a second connecting step of connecting other terminals among the plurality of terminals to any of the plurality of strip conductors in a one-to-one configuration,
wherein in the cutting step, the base is cut longer when cutting out the terminals than when cutting out the other terminals, and
wherein in the first connecting step, the bases of the terminals are each connected to the two or more strip conductors.
